(19) United States
(12) Patent Application Publication
(10) Pub. No.: US 2002/0127524 A1
(43) Pub. Date: Sep. 12, 2002

(54) Responsibility organizer

(76) Inventors: Laurie Ann Kowalke, Baraboo, WI (US); Steven Richard Kowalke, Baraboo, WI (US)

Correspondence Address: Laurie Kowalke, 603 Sixth Street, Baraboo, WI, 53913, US

(21) Appl. No.: 09/942,559

(22) Filed: Aug. 31, 2001

Related U.S. Application Data
(60) Provisional application No. 60/229,574, filed on Aug. 31, 2000.

(51) Int. Cl. G09B 19/00

(52) U.S. Cl. 434/238

(57) ABSTRACT

A circular device with two parts when put together where tasks and names or numbers are written upon them quickly easily and fairly divide duties.

### CROSS-REFERENCE TO RELATED APPLICATION

This application claims the benefit of Ser. No. 60/229,574 filed on Aug. 31, 2000.

### FIELD OF INVENTION

The present invention relates to the organization of tasks to be performed by individuals, either children in classrooms or at home, or adults in various work environments or other places where quick and easy organization is desired. It also can be used as an aide in teaching or used as a type of game where a pointer can point to a name to answer questions or the like.

### BACKGROUND OF THE INVENTION

Organization of various tasks and jobs in school and home environments are frustrating and time consuming. These troublesome problems of keeping track of whom does what and when can be alleviated with a slight turn of a wheel. Another problem that occurs is the ever changing classroom population. With this organization device, the names are easily changed. The organizational device is not only able to assign jobs, but it is great for putting the students in groups. The ability to tack, magnetize or Velcro the wheel is also a necessary component because of the limited space in classrooms.

### SUMMARY OF THE INVENTION

The present invention addresses the above-mentioned problems and other problems by providing a new organizational tool. According to one embodiment, the wheel would have a stationary back and a moveable front. Names would be present on a back wheel which would be stationary. The front wheel would be moveable and have windows to expose the names of students or adults. The various tasks would be listed on the front wheel adjacent to the window to allow the person, whose name appears to perform that task. For example, a teacher in a classroom, who wishes to change jobs for her students weekly could easily accomplish the task by simply and quickly rotating the wheel to a different set of names. She can continue this process until the wheel has turned 360 degrees giving students different tasks until the process starts over again.

According to another embodiment, the invention includes a bottom circular plate containing a plurality of names, such as grade-school students, equally spaced around the circumference of the bottom plate, and a circular upper plate rotatabily secured to the bottom plate, wherein the upper plate includes a plurality of responsibilities, such as classroom chores or assignments, equally positioned around the circumference of the adapted to be placed over the top of the names on the bottom plate, so that the names can be seen there through. According to one aspect of the invention, a teacher can set the upper wheel at a particular position on Day 1 so that each student listed on the bottom plate has a given assignment for Day 1. On Day 2, the teacher can rotate the upper plate one position so that each student listed on the bottom plate has a different job or task on Day 2. And so forth until the upper plate has rotated 360 degrees with respect to the bottom plate, whereafter the process is started again. Basically, the wheel is set-up such that each student will perform each chore listed on the wheel, before having to do the some chore twice.

The organizer can include various additional features, such as providing erasable surfaces for the upper and bottom plates, so that the organizer can be used for various situations, and so that the surfaces are re-usable. The wheel could include an appropriate locking device such that the upper plate locks into place when rotated one position, and further includes an unlocking device so the upper plate can be rotated when operating the wheel one does not forget which direction the wheel turns. Other features could be provided to enhance the operation of the organizer. Such features include overlapping co-axial wheels each having a set of parameters around the wheel which may be aligned with each other by rotating one wheel against the other, such an arrangement having windows for viewing the lower wheel through the upper wheel, such an arrangement where one wheel holds names or the like and the other holds chores or the like, and such an arrangement where the wheels include erasable surfaces.

Other features and advantages of the invention will become apparent to those skilled in the art upon review of the following detailed description, claims and drawing in which like numerals are used to designate like features.

### BRIEF DESCRIPTION OF THE DRAWINGS

FIG. 1 is a perspective view of an organizer according to the present invention.

FIG. 2 is a perspective view of the back plate of the organizer with the rectangular boxes being the outlines for the names or numbers.

FIG. 3 is a front view of the front plate of the organizer with the rectangles being cut out to become windows.

FIG. 4 is a back view of the front plate of the organizer.

FIG. 5 is a perspective view of a stand for the organizer.

FIG. 6 is an illustrative view of a sprocket spring device for the organizer.

FIG. 7 is a perspective view of a pivot pin for the organizer.

FIG. 8 is a perspective view of an alternative organizer according to the present invention.

FIG. 9 is a perspective view of the back plate of the organizer shown in

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting.

### BRIEF DESCRIPTION OF THE INVENTION

Referring to the drawing, this invention will relate to the organization of various tasks by individuals, either children or adults to be able to keep track of whom does what, in a quick, easy and efficient manner.

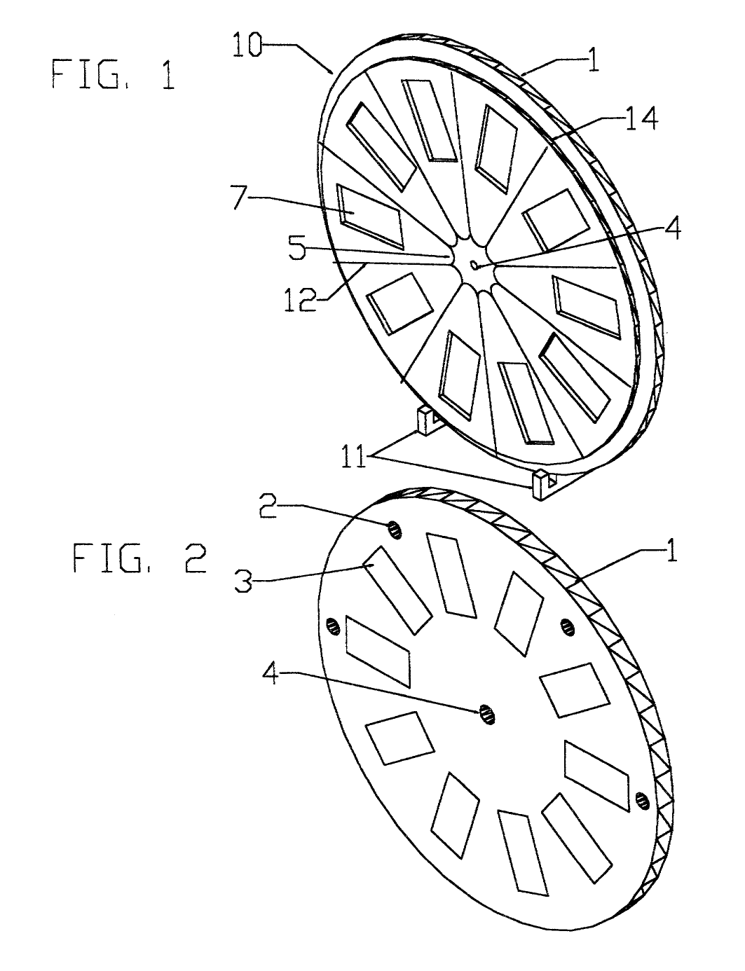

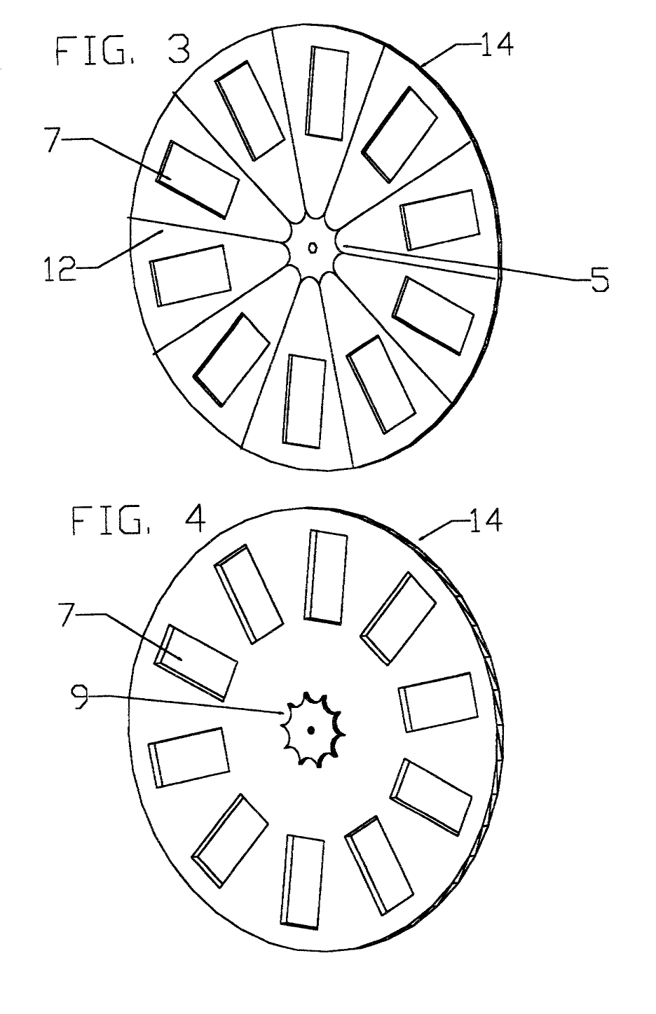

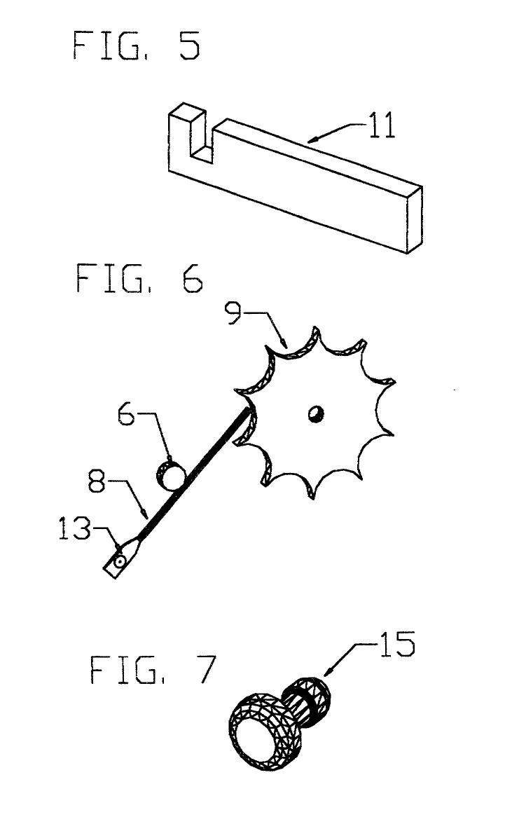

FIG. 1 shows an organizer or wheel 10 in its complete form with the back plate 1 (FIG. 2) being slightly larger than the front plate 14 (FIG. 3). The back plate 1 is slightly larger to accommodate a stand 11 (FIG. 5) which would allow the wheel 10 to be placed on a table or filing cabinet or the like. Another feature of the larger back plate 1 is holes 2 (FIG. 2) near the top and sides for pinning the wheel 10 to wall or for hanging with string, wire or various other methods of hanging.

FIG. 3 shows a sprocket look-a-like 5 on the front plate 14 with lines 12 drawn from the outside of the plate 14 to the sprocket 5. The sprocket 5 is similar to a sprocket for a bike wheel. The lines 12 divide the plate 14 into equal parts between the windows 7. The division of lines 12 allows for tasks to be written between said lines so as to correspond to each individual's name showing through the window 7. The back plate 1(FIG. 2) has a corresponding outline of the window 3 to match up to the window 7 on plate 14, so when front plate 14 matches up to back plate 1, a name or number is revealed through the window 7. That person is then responsible for the task written between the lines 12 (FIG. 3). Each time the front plate 14 is turned, it moves window 7 to reveal another name or number as so desired. FIG. 4 shows the back side of the front plate 14, to reveal the sprocket 9 (FIG. 6) which when engaged into sprocket spring 8 (FIG. 6) allows for the front plate 14 to turn in only one direction.

The sprocket spring 8 (FIG. 6) is attached to the front of the back plate 1 and is held in place by a rivet 13 or other suitable fastening means to hold it securely. The sprocket spring 8 rests against a removable stationary post 6 which holds the sprocket spring 8 from spinning away from the sprocket 9. As the sprocket 9 turns, it pushed against the sprocket spring 8 until it passes a point of the sprocket 9 and rests in between two points of the sprocket 9. If one were to turn the front plate 14 backwards, the point of the sprocket 9 would hit against the sprocket spring 8, not allowing for the front plate 14 to turn in that direction.

A pivot hole 4 (FIG. 1) is established between the back plate 1 and the front plate 14 and is held together with a pivot pin 15 (FIG. 7) which would allow for the plate 14 to turn freely as well. The pivot pin 15 would be easily removable to allow for separation of the front plate 14 and the back plate 1. Such pivot pins are readily commercially available from many different companies, such as McMaster Carr. The pivot pin may be made out of any suitable material, but a nylon material would be suitable. The pivot pin or the like will allow for easy removal of the names in the corresponding window 3 on the back plate 1. The names can be written with removable marker or any other suitable means. The front plate 14 and the back plate 1 would be made out of such material as to address easy addition or removal of names, tasks, numbers and the such. Multiple front plates and back plates could be made to allow for different multiples of individuals or jobs. They could be color coded to distinguish which front plate would correspond to which back plate. For instance, a front plate 14 having twelve windows with twelve individual rectangles on the back plate 1 have tasks at one time. If the time frame for the tasks was one day, a slight turn of the front plate would reveal another twelve names on the back plate and they then would have a different task to perform.

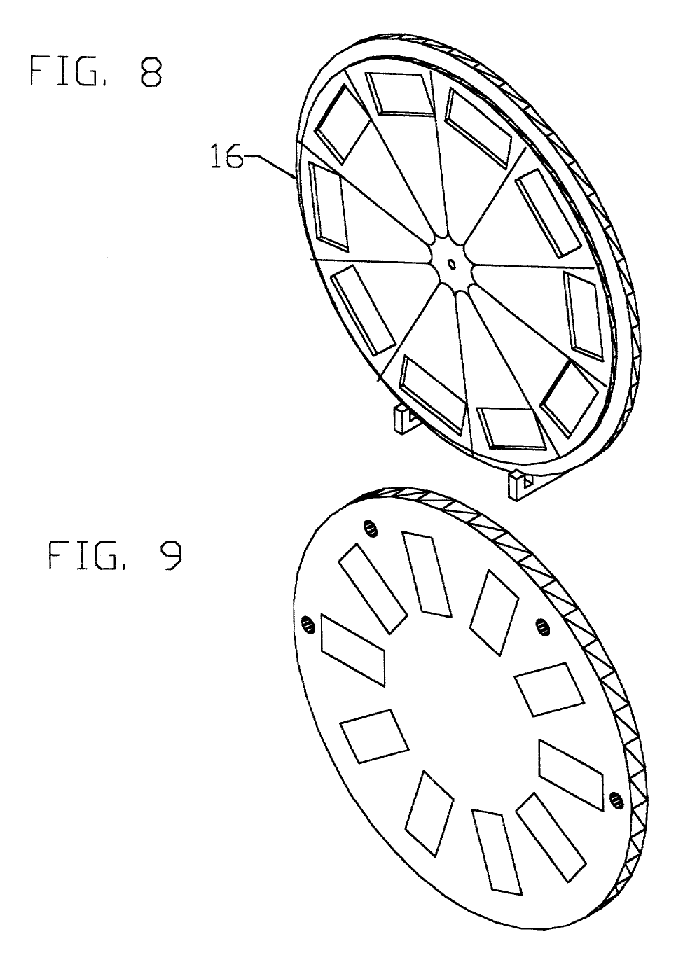

Another wheel 16 (FIG. 8) will have windows 7 in more of a horizontal pattern with the corresponding windows 3 being exposed to reveal names through every window. In that way everyone will have a task all the time. With other arrangements, names could come up for tasks every other time. Wheel 16 could have a sprocket mechanism like the mechanism shown in FIG. 6 to allow the front plate to turn in one direction. The wheel 16 is similar to the wheel 10. If one would want to eliminate the sprocket mechanism (FIG. 6), the stationary post 6 would be removed. It would be placed back in service if one wanted the sprocket action to work again.

Another variance may be the back plate 1 could have the rectangles as shown however the front plate 14 may only have one window 7. This way only one name would be showing at a time while many names could be placed on the back plate 1.

The parts list is as follows:

1 Back plate

2 Back plate mounting holes

3 Corresponding window outlines

4 Pivot hole

5 Sprocket-look-a-like

6 Removable stationary post

7 Window

8 Sprocket spring

9 Sprocket

10 Complete wheel

11 Stand

12 Lines

13 Rivet

14 Front plate

15 Pivot pin

16 Another wheel

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. An organizer having a first stationary plate and a second plate which rotates about said first plate.
A device with two circular surfaces attached together wherein the back circle has outlines strategically placed so as to enable the writing of names or numbers or the like.
a front circle wherein when attached to back circle, with ability to turn tasks are divided up equally and an opening configured to be alienable to name or number in said circle when front circle is turned it reveals a different name or number in said circle thus changing tasks.

2. An organizing device as set forth in claim 1 where the front and back are attached through the center thus holding the circles together.

3. An organizing device as set forth in claim 2 further comprising a lock with a stationary post with the lever pressing against the socket as to allow one way rotation for front circle as set forth in claim 1 wherein the front circle is able to turn.

4. An organizing device as set forth in claim 1 which is divided equally with openings alienable front circle thus equally dividing tasks to be performed.

5. An organizing device as set forth in claim 1 where an opening configured to be alienable in front circle can equal names or numbers on said circle.
A front circle can be divisibly configured to fractionally equalize tasks.

6. An organizing device as set forth in claim 5 whereby said circle in claim 1 can have multiple outlines and front circle may have 1 opening to be configured to match said outlines.
